(19) United States
(12) Patent Application Publication
(10) Pub. No.: US 2026/0003809 A1
(43) Pub. Date: Jan. 1, 2026

(54) PREEMPTION OF DIRECT MEMORY ACCESS PROCESSING FOR CONTEXT SWITCH

(71) Applicant: ADVANCED MICRO DEVICES, INC., Santa Clara, CA (US)

(72) Inventors: Ian Richard Beaumont, Sydney (AU); Jeffrey C. Allan, Boxborough, MA (US); Sreekanth Godey, Santa Clara, CA (US); Ramkumar Jayaseelan, Austin, TX (US); Randy Ramsey, Orlando, FL (US); Joseph L. Greathouse, Austin, TX (US)

(21) Appl. No.: 18/757,929

(22) Filed: Jun. 28, 2024

(51) Int. Cl. G06F 13/28; G06T 1/60

(52) U.S. Cl. CPC G06F 13/28; G06T 1/60

(57) ABSTRACT

A direct memory access (DMA) controller issuing memory copy operations on behalf of a shader at a parallel processor stops issuing copy operations upon a context switch at the shader for a wave. The DMA controller or a trap handler associated with the shader saves the incomplete copy operations to a region of global memory, from which the incomplete operations are restored upon a context resume for the wave.

### BACKGROUND

A system direct memory access (DMA) controller is a hardware device which coordinates direct memory access transfers of data between devices (e.g., input/output interfaces and display controllers) and memory, or between different locations in memory, within a computer system. A DMA controller is often located on a processor, such as a central processing unit (CPU) or an accelerated processing unit such as a parallel processor and receives commands from an application running on the processor. Based on the commands, the DMA controller reads data from a DMA source (e.g., a first memory buffer defined in memory) and writes data to a DMA destination (e.g., a second buffer defined in memory).

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system configured to save incomplete direct memory access copy operations upon a context switch for later restoration in accordance with some embodiments.

FIG. 2 is a block diagram illustrating normal operation of a shader tasking a DMA controller with tensor load/store operations in accordance with some embodiments.

FIG. 3 is a block diagram illustrating a shader instructing a DMA controller to halt incomplete tensor load/store operations and save incomplete descriptors in response to a context switch in accordance with some embodiments.

FIG. 4 is a block diagram illustrating a shader instructing a DMA controller to resume unrolling incomplete tensor load/store operations based on restored descriptors in accordance with some embodiments.

FIG. 5 is a flow diagram illustrating a method for saving incomplete DMA copy operations for subsequent restoration in response to a context switch in accordance with some embodiments.

### DETAILED DESCRIPTION

Applications (e.g., shader programs, raytracing programs) executing on a processing system generate program code indicating a plurality of work items (e.g., functions, operations) to be performed for the application. In some embodiments, the processing system is configured to group such work items into one or more workgroups each including a respective number of waves (e.g., sub-groups of work items) to be performed. To execute these waves for a workgroup, the processing system includes a parallel processor that has one or more shader engines (also referred to herein as shaders) that in turn each include one or more compute units.

The parallel processor may include one or more DMA controllers (also referred to as DMA engines) to read and write blocks of data stored in a system memory. The DMA controllers relieve shaders from the burden of managing transfers. In response to data transfer requests from the shaders, the DMA controllers provide requisite control information to the corresponding source and destination such that data transfer operations can be executed without delaying computation code, thus allowing communication and computation to overlap in time. With the DMA controllers asynchronously handling the formation and communication of control information, the shaders are freed to perform other tasks while awaiting satisfaction of the data transfer requests. Typically, a DMA controller copies data from one location to another by performing load/store operations in which the DMA controller loads the data from system memory (e.g., dynamic random-access memory (DRAM)) over, e.g., a Peripheral Component Interconnect Express (PCIe) bus, and stores the data at another memory component such as a static random-access memory (SRAM) that is local to a shader. For example, a DMA engine manually requests data to be loaded into a scratchpad memory from system memory via a memory hierarchy (which may contain one or more caches at different levels within the memory hierarchy). Each level of the memory hierarchy may include a cache which may be populated (e.g., with specific cache directives from the requester) as data is loaded from a lower level and returned to a requester.

For applications such as machine learning, some of the data structures that are processed in waves executed by shaders of a parallel processor are tensors, which are multi-dimensional arrays of numbers that represent complex data. A shader may task a DMA controller with tensor load/store operations such as copying tensor data from global memory to local memory and vice versa. Each tensor load/store operation is indicated by a descriptor, which specifies the tensor's location in memory as well as characteristics of the tensor such as the tensor width and stride and whether the tensor is to be copied from global memory to local memory or from local memory to global memory. Based on each descriptor, the DMA controller generates multiple (e.g., hundreds or thousands) of memory copy requests.

In some situations where the processing system switches from execution of one application to another (i.e., a context switch), the processing system allows the parallel processor to preempt shader execution in the middle of execution of a wave. During the preemption process, all outstanding operations of a wave are drained (i.e., allowed to complete) before entering a trap handler which saves data upon context switch and restores data upon context resume. However, the preemption process must complete within system time limits or risks being shut down by the operating system. Because of the large number of memory copy requests the DMA controller generates for each wave asynchronously from the shader operations, in many cases waiting for all the outstanding operations of the DMA controller to drain will exceed system time limits.

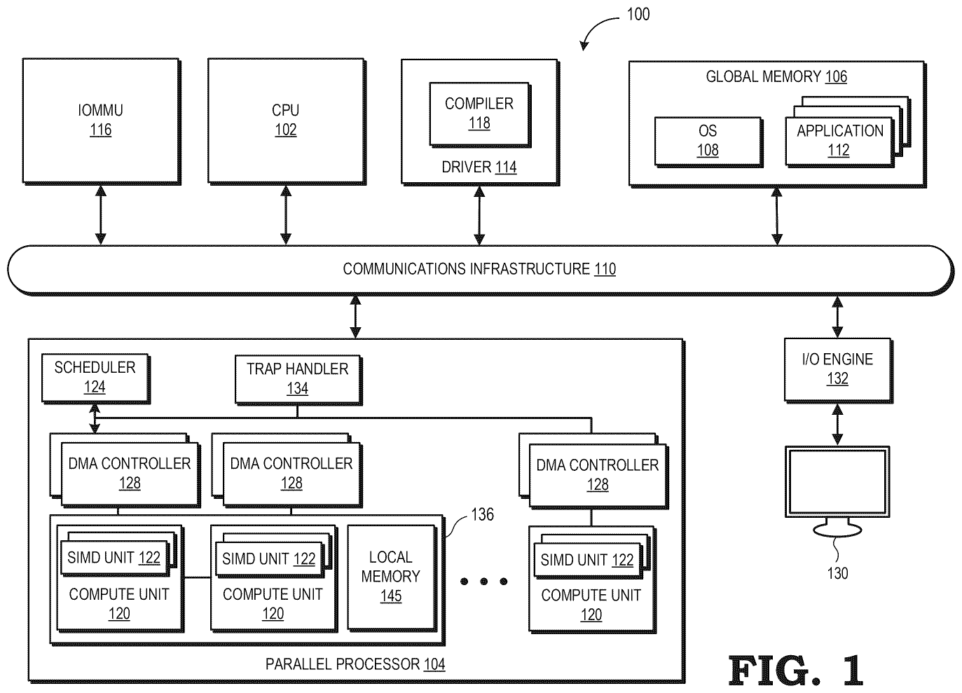

FIGS. 1-5 illustrate techniques for halting DMA controller operations on behalf of a shader at a parallel processor upon a context switch and saving incomplete DMA controller memory operations for an in-progress wave to memory, from which the incomplete memory operations are restored upon context resume. In some implementations, the DMA controller issues instructions based on descriptors to perform copy operations to copy data between a global memory of the parallel processor and a local memory of the shader and, in response to a context switch at the shader, stops performing the copy operations. The DMA controller saves the descriptor(s) for any incomplete copy operations as of the time of the context switch to a portion of the global memory. In some implementations, the DMA controller also saves metadata indicating the number of saved descriptors to the portion of the global memory. In response to a context resume at the shader (also referred to as a context restore), in some embodiments the shader reads the saved descriptors and metadata and instructs the DMA controller to resume issuing instructions based on the saved descriptors. Because new descriptors may have been received by the DMA controller after the context switch and prior to the context restore, in some implementations the DMA controller prioritizes issuing instructions based on the saved descriptor(s) of incomplete copy operations over issuing instructions based on the new descriptors.

The techniques described herein are, in different embodiments, employed at any of a variety of parallel processors (e.g., accelerated processing units (APUs), vector processors, graphics processing units (GPUs), general-purpose GPUs (GPGPUs), non-scalar processors, highly-parallel processors, artificial intelligence (AI) processors, neural network (NN) accelerators, inference engines, machine learning processors, other multithreaded processing units, and the like). FIG. 1 illustrates an example of a processing system 100 including a parallel processor 104, in accordance with some embodiments. In at least some embodiments, the processing system 100 is a computer, laptop/notebook, mobile device, gaming device, wearable computing device, server, or any of various other types of computing systems or devices. It is noted that the number of components of the processing system 100 varies from embodiment to embodiment. In at least some embodiments, there is more or fewer of each component/subcomponent than the number shown in FIG. 1. It is also noted that the processing system 100, in at least some embodiments, includes other components not shown in FIG. 1. Additionally, in other embodiments, the processing system 100 is structured in other ways than shown in FIG. 1.

The parallel processor 104, in some embodiments, renders images for presentation on a display 130. For example, the parallel processor 104 renders objects to produce values of pixels that are provided to the display 130, which uses the pixel values to display an image that represents the rendered objects. The parallel processor 104 includes a plurality of compute units (CU) 120 that execute instructions concurrently or in parallel. In some embodiments, each one of the CUs 120 includes one or more single instruction, multiple data (SIMD) units, and the CUs 120 are aggregated into workgroup processors, shader arrays, shader engines, or the like, such as shader engine 136 (also referred to herein as shader 136). The number of CUs 120 implemented in the parallel processor 104 is a matter of design choice and some embodiments of the parallel processor 104 include more or fewer compute units than shown in FIG. 1. In some embodiments, the CUs 120 are used to implement a graphics or texture pipeline such as graphics processing pipeline 126, as discussed herein. In some embodiments, the parallel processor 104 is used for general purpose computing.

The processing system 100 further includes a central processing unit (CPU) 102. The CPU 102, in at least some embodiments, includes one or more single- or multi-core CPUs. In various embodiments, the parallel processor 104 includes any cooperating collection of hardware and or software that perform functions and computations associated with accelerating graphics processing tasks, data-parallel tasks, nested data-parallel tasks in an accelerated manner with respect to resources such as conventional CPUs, conventional graphics processing units (GPUs), and combinations thereof.

As illustrated in FIG. 1, the processing system 100 also includes a system memory referred to herein as global memory 106, an operating system 108, a communications infrastructure 110, and one or more applications 112. Access to the global memory 106 is managed by a memory controller (not shown) coupled to global memory 106. For example, requests from the CPU 102 or other devices for reading from or for writing to the global memory 106 are managed by the memory controller. In some embodiments, the one or more applications include various programs or commands to perform computations that are also executed at the CPU 102. The CPU 102 sends selected commands for processing at the parallel processor 104. The parallel processor 104 executes instructions such as program code of one or more applications 112 stored in the global memory 106 and the parallel processor 104 stores information in the global memory 106 such as the results of the executed instructions.

The operating system 108 and the communications infrastructure 110 are discussed in greater detail below. The processing system 100 further includes a driver 114 and a memory management unit, such as an input/output memory management unit (IOMMU) 116. Components of the processing system 100 are implemented as hardware, firmware, software, or any combination thereof. In some embodiments, the processing system 100 includes one or more software, hardware, and firmware components in addition to or different from those shown in FIG. 1.

Within the processing system 100, the global memory 106 includes non-persistent memory, such as DRAM (not shown). In various embodiments, the global memory 106 stores processing logic instructions, constant values, variable values during execution of portions of applications or other processing logic, or other desired information. For example, in various embodiments, parts of control logic to perform one or more operations on the CPU 102 reside within the global memory 106 during execution of the respective portions of the operation by the CPU 102. During execution, respective applications, operating system functions, processing logic commands, and system software reside in the global memory 106. Control logic commands that are fundamental to the operating system 108 generally reside in the global memory 106 during execution. In some embodiments, other software commands (e.g., a set of instructions or commands used to implement the device driver 114) also reside in the global memory 106 during execution by the processing system 100.

The IOMMU 116 is a multi-context memory management unit. As used herein, context is considered the environment within which kernels execute and the domain in which synchronization and memory management is defined. The context includes a set of devices, the memory accessible to those devices, the corresponding memory properties, and one or more command-queues used to schedule execution of a kernel(s) or operations on memory objects. The IOMMU 116 includes logic to perform virtual to physical address translation for memory page access for devices, such as the parallel processor 104. In some embodiments, the IOMMU 116 also includes, or has access to, a translation lookaside buffer (TLB) (not shown). The TLB is implemented in a content addressable memory (CAM) to accelerate translation of logical (i.e., virtual) memory addresses to physical memory addresses for requests made by the parallel processor 104 for data in the global memory 106.

In various embodiments, the communications infrastructure 110 interconnects the components of the processing system 100. The communications infrastructure 110 includes (not shown) one or more of a peripheral component interconnect (PCI) bus, extended PCI (PCI-e) bus, advanced microcontroller bus architecture (AMBA) bus, advanced graphics port (AGP), or other such communication infrastructure and interconnects. In some embodiments, the communications infrastructure 110 also includes an Ethernet network or any other suitable physical communications infrastructure that satisfies an application's data transfer rate requirements. The communications infrastructure 110 also includes the functionality to interconnect components, including components of the processing system 100.

A driver 114 communicates with a device (e.g., parallel processor 104) through an interconnect or the communications infrastructure 110. When a calling program invokes a routine in the driver 114, the driver 114 issues commands to the device. Once the device sends data back to the driver 114, the driver 114 invokes routines in an original calling program. In general, drivers are hardware-dependent and operating-system-specific to provide interrupt handling required for any necessary asynchronous time-dependent hardware interface. In some embodiments, a compiler 118 is embedded within the driver 114. The compiler 118 compiles source code into program instructions as needed for execution by the processing system 100. During such compilation, the compiler 118 applies transforms to program instructions at various phases of compilation. In other embodiments, the compiler 118 is a standalone application. In various embodiments, the driver 114 controls operation of the parallel processor 104 by, for example, providing an application programming interface (API) to software (e.g., applications) executing at the CPU 102 to access various functionality of the parallel processor 104.

The CPU 102 includes (not shown) one or more of a control processor, field-programmable gate array (FPGA), application-specific integrated circuit (ASIC), or digital signal processor (DSP). The CPU 102 executes at least a portion of the control logic that controls the operation of the processing system 100. For example, in various embodiments, the CPU 102 executes the operating system 108, the one or more applications 112, and the driver 114. In some embodiments, the CPU 102 initiates and controls the execution of the one or more applications 112 by distributing the processing associated with one or more applications across the CPU 102 and other processing resources, such as the parallel processor 104.

The parallel processor 104 executes commands and programs for selected functions, such as graphics operations and other operations that are particularly suited for parallel processing. In general, the parallel processor 104 is frequently used for executing graphics pipeline operations, such as pixel operations, geometric computations, and rendering an image to a display. In some embodiments, the parallel processor 104 also executes compute processing operations (e.g., those operations unrelated to graphics such as video operations, physics simulations, computational fluid dynamics, etc.), based on commands or instructions received from the CPU 102. For example, such commands include special instructions that are not typically defined in the instruction set architecture (ISA) of the parallel processor 104.

The SIMD execution model is one in which multiple processing elements share a single program control flow unit and program counter and thus execute the same program but are able to execute that program with different data. The number of compute units 120 implemented in the parallel processor 104 is configurable. Each compute unit 120 includes one or more processing elements such as scalar and or vector floating-point units, arithmetic and logic units (ALUs), and the like. In various embodiments, the compute units 120 also include special-purpose processing units (not shown), such as inverse-square root units and sine/cosine units.

Each of the one or more compute units 120 executes a respective instantiation of a particular work item to process incoming data, where the basic unit of execution in the one or more compute units 120 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a compute unit 120.

The parallel processor 104 issues and executes work-items, such as groups of threads executed simultaneously as a “wave”, on a single SIMD unit 122. Waves, in at least some embodiments, are interchangeably referred to as wavefronts, warps, vectors, or threads. In some embodiments, waves include instances of parallel execution of a shader program, where each wave includes multiple work items that execute simultaneously on a single SIMD unit 122 in line with the SIMD paradigm (e.g., one instruction control unit executing the same stream of instructions with multiple data). A scheduler 124 is configured to perform operations related to scheduling various waves on different CUs 120 and SIMD units 122 and performing other operations to orchestrate various tasks on the parallel processor 104.

To reduce latency associated with off-chip memory access, various parallel processor architectures include a local memory 145 implemented as, e.g., a memory cache hierarchy including, for example, L1 cache and a local data share (LDS). The LDS is a high-speed, low-latency memory private to each shader 136. In some embodiments, the LDS is a full gather/scatter model so that a workgroup writes anywhere in an allocated space.

The parallelism afforded by the one or more CUs 120 is suitable for graphics-related operations such as general-purpose compute and tensor operations, pixel value calculations, vertex transformations, tessellation, geometry shading operations, ray tracing, path tracing, and other graphics operations. In some implementations, the scheduler 124 issues work to the compute units 120 to perform general purpose compute operations, including operations to accelerate the calculation of tensor operations. Some parallel computation operations require that the same command stream or compute kernel be performed on streams or collections of input data elements. Respective instantiations of the same compute kernel are executed concurrently on multiple SIMD units 122 in the one or more compute units 120 to process such data elements in parallel. As referred to herein, for example, a compute kernel is a function containing instructions declared in a program and executed on parallel processor compute unit 120.

In some embodiments, the processing system 100 includes input/output (I/O) engine 132 that includes circuitry to handle input or output operations associated with display 130, as well as other elements of the processing system 100 such as keyboards, mice, printers, external disks, and the like. The I/O engine 132 is coupled to the communications infrastructure 110 so that the I/O engine 132 communicates with the global memory 106, the parallel processor 104, and the CPU 102. In some embodiments, the CPU 102 issues one or more draw calls or other commands to the parallel processor 104. In response to the commands, the parallel processor 104 schedules, via the scheduler 124, one or more operations at the shaders 136. Based on the operations, the parallel processor 104 generates a rendered frame, and provides the rendered frame to the display 130 via the I/O engine 132.

In some embodiments, the processing system includes a trap handler 134 that is implemented as hardware, software, or a combination thereof for capturing an executing wave when an exception or interrupt occurs. The trap handler 134 is an exception handler that transfers control to a privileged space in the operating system 108 in which instructions can execute outside of the applications 112.

To facilitate transfers of data between the local memory 145 and the global memory 106, the shader 136 tasks a DMA controller 128 associated with the shader 136 with issuing instructions to copy data from the local memory 145 to the global memory 106 (i.e., store instructions) and from the global memory 106 to the local memory 145 (i.e., load instructions). In some implementations, each compute unit 120 includes four SIMD units 122, and each pair of SIMD units 122 connects to a DMA controller 128, such that each DMA controller 128 performs tensor load/store operations on behalf of its associated pair of SIMD units 122. The DMA controller 128 performs the copy operations asynchronously from the shader 136, such that the shader 136 is free to perform other tasks while awaiting satisfaction of the copy operations. For a given tensor load/store operation offloaded from the shader 136 to the DMA controller 128, the DMA controller 128 may generate hundreds or thousands of memory copy requests. In some implementations, the shader 136 tasks the DMA controller 128 with copy operations by providing a descriptor (not shown) that contains information regarding the data (e.g., tensor) to be copied. For example, the descriptor includes tensor dimensions, tile dimensions, strides, padding, the global memory address to or from which the tensor is to be copied, and the local memory address to or from which the tensor is to be copied. The DMA controller 128 “unrolls” the descriptor by generating the memory copy requests indicated by the descriptor. The descriptor is accompanied by metadata in some implementations. In some implementations, the shader 136 also provides the DMA controller 128 with instruction set architecture (ISA) fields specifying, e.g., the scope of memory operations.

Upon the occurrence of a context switch, rather than waiting for the DMA controller 128 to complete satisfying outstanding copy requests for a currently executing wave before entering a trap handler 134, the shader 136 enters the trap handler 134 and the trap handler 134 issues an instruction to the DMA controller 128 to stop outstanding DMA operations. The DMA controller 128 halts unrolling any further descriptors for the wave in response to receiving the instruction and, in some implementations, saves any outstanding descriptors for DMA operations into a region of the global memory 106 that is designated for the wave. In some implementations, the outstanding descriptors are read out directly by the trap handler 134 and saved, by the shader's trap handler software, into the region of the global memory 106 that is designated for the wave. Thus, depending on the implementation, the trap handler 134 either directly or indirectly (via instructions to the DMA controller 128) saves the outstanding descriptors to the region of the global memory 134 that is designated for the wave. By halting unrolling descriptors and saving descriptors for unissued copy requests to the region of memory, the process of preempting shader execution in the middle of the wave can be completed more quickly, reducing the likelihood of exceeding system time limits. Upon a context restore, the trap handler 134 reads the saved descriptor(s) from the region of global memory 106 that is designated for the wave and instructs the DMA controller 128 to resume unrolling the saved descriptor(s). By restoring the saved descriptor(s) to the DMA controller 128, the trap handler 134 allows the DMA controller 128 to resume issuing copy instructions from the point at which the DMA controller 128 halted issuing copy instructions in response to the context switch.

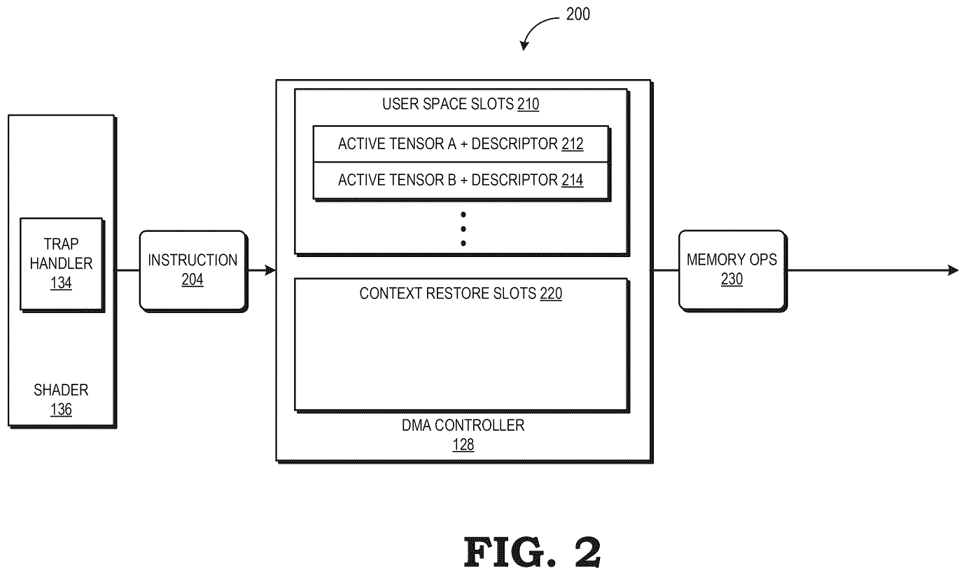

FIG. 2 is a block diagram illustrating normal operation of a shader 136 tasking a DMA controller 128 with tensor load/store operations in the absence of a context switch in accordance with some embodiments. In some implementations, the DMA controller 128 includes a set of user space slots 210 to hold descriptors and associated metadata for memory operations such as tensor load/store operations for a currently executing application 112 as well as a set of context restore slots 220 to hold descriptors and associated metadata for memory operations for restored memory operations such as tensor load/store operations for a restored application 112 upon context resume following a context switch.

A sequencer (not shown) within the shader 136 issues instructions on a per-wave basis in some implementations. Thus, for a given wave, the shader 136 issues an instruction, such as tensor load/store operation instruction 204, to the DMA controller 128. The tensor load/store operation instruction 204 is either a load instruction or a store instruction which is accompanied by a descriptor. The descriptor contains information regarding the tensor load/store operation such as tensor dimensions, tile dimensions, strides, padding, global memory address, local memory address, and a metadata portion which includes information for identifying context restore operations. In the illustrated example, the tensor load/store operation instruction 204 is an instruction generated by a currently executing application 112 (i.e., not a restored instruction following a context switch) for TENSOR load/store operation A, and is therefore not accompanied by metadata (or is accompanied by null metadata). In some implementations, the tensor load/store operation is also accompanied by associated ISA fields, e.g., to identify a scope of memory operations.

In response to receiving the tensor load/store operation instruction 204, the DMA controller 128 stores the tensor load/store operation for ACTIVE TENSOR A and a descriptor 212 in one of the user space slots 210. In the illustrated example, the DMA controller 128 also stores a tensor load/store operation for ACTIVE TENSOR B plus a descriptor 214 at another of the user space slots 210. In some implementations, hardware (not shown) within the DMA controller 128 reads the descriptor 212 and the descriptor 214 and unrolls (issues) memory operations 230 required for each of the descriptor 212 and the descriptor 214.

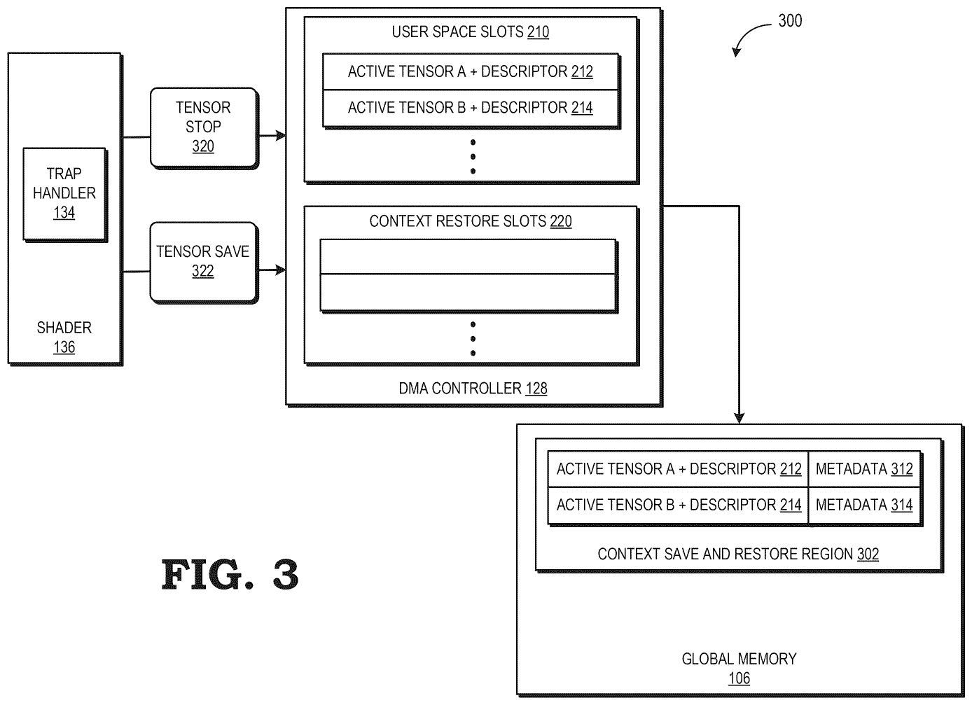

FIG. 3 is a block diagram illustrating the trap handler 134 associated with the shader 136 instructing the DMA controller 128 to halt unrolling any incomplete tensor load/store operations and to save descriptors for the incomplete tensor load/store operations in response to a context switch in accordance with some embodiments. In response to a context switch that preempts execution of a wave at the shader 136, the shader 136 does not wait for the DMA controller 128 to complete unrolling all descriptors for the wave before entering the trap handler 134. Rather than completing unrolling all descriptors for the wave, which could exceed system time limits for the context switch and lead to the operating system 108 shutting down the application 112, the trap handler 134 issues a tensor stop instruction 320 to stop any outstanding DMA operations for the wave.

In response to receiving the tensor stop instruction 320, the DMA controller 128 halts unrolling any tensor load/store operations for the wave indicated by descriptors that have not yet completed unrolling. Any descriptors for which all associated memory operations 230 have already issued are allowed to complete and the DMA controller 128 frees the slots they had occupied as if those tensor load/store operations had completed. It is possible for an outstanding memory operation 230 to cause a page fault or memory violation, and the tensor stop instruction 320 ensures that the DMA controller 128 has paused further processing and that no other instructions remain outstanding that could fail.

The trap handler 134 then issues a tensor save instruction 322 to the DMA controller 128 instructing the DMA controller 128 to save any outstanding tensor load/store operations and associated descriptors for the wave to a context save and restore region 302 of the global memory 106. Each tensor load/store operation and descriptor is accompanied by metadata which stores ISA fields, an indication of the number (count) of descriptors in the context save and restore region 302, and an indication that the descriptor is a context restore descriptor. In the example illustrated in FIG. 3, the DMA controller 128 has not yet begun unrolling the tensor load/store operations for ACTIVE TENSOR A and descriptor 212 and ACTIVE TENSOR B and descriptor 214 when the tensor stop instruction 320 is received, in which case the tensor load/store operations for ACTIVE TENSOR A and descriptor 212 and ACTIVE TENSOR B and descriptor 214 are deemed outstanding tensor load/store operations.

After issuing the tensor stop instruction 320 for the wave, the trap handler 134 issues a tensor save instruction 322 to the DMA controller 128. In response to receiving the tensor stop instruction 320, the DMA controller 128 sends a request for the ACTIVE TENSOR A and descriptor 212 and associated metadata 312, and ACTIVE TENSOR B and descriptor 214 and associated metadata 314 to be written out into the context save and restore region 302 of the global memory 106. In the illustrated example, the metadata 312, 314 indicates a count of two saved descriptors, which tells the trap handler 134 and the DMA controller 128 how many tensor instructions to issue on context resume.

In some implementations, the trap handler 134 issues at least one tensor load/store operation in the tensor save instruction 322, even if the count of outstanding tensor load/store operations is zero, to allow the DMA controller 128 to inform the scheduler 124 when the context restore is complete. In the event there are no outstanding tensor load/store operations for a wave, the trap handler 134 writes to the metadata region of the descriptor in the context save and restore region 302 for the wave to indicate that there are zero outstanding tensor load/store operations and an indication that the descriptor is a context restore descriptor.

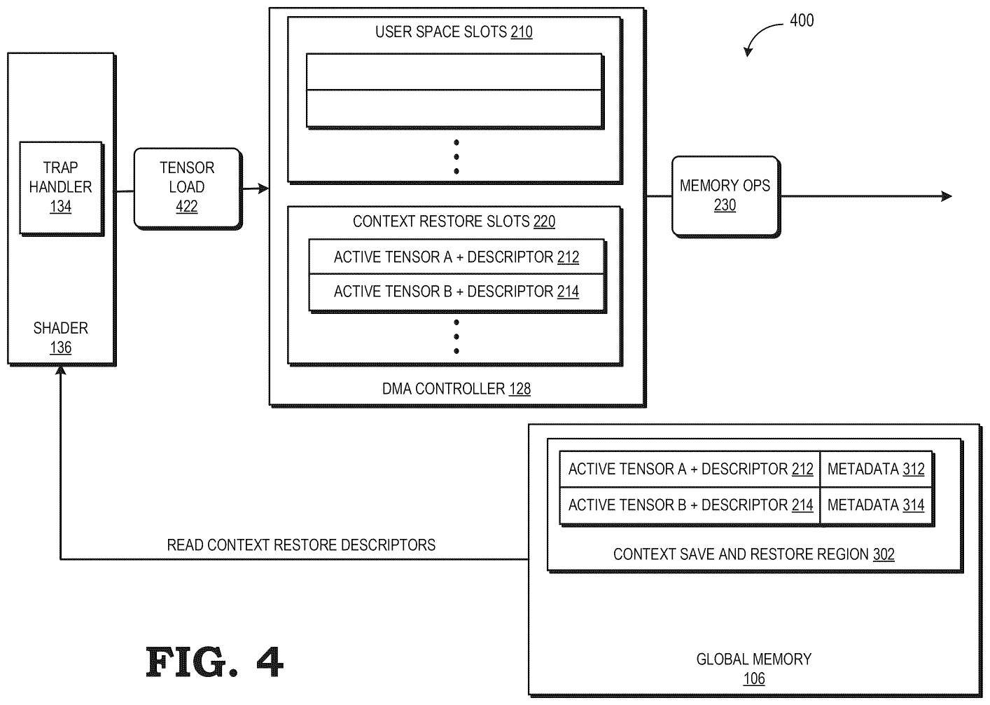

FIG. 4 is a block diagram illustrating the shader 136 instructing the DMA controller 128 to resume unrolling incomplete tensor load/store operations based on restored descriptors in accordance with some embodiments. In some implementations, upon context resume, the trap handler 134 determines if the wave that is to be restored includes DMA operations based on an indication associated with the wave. If the wave that is to be restored includes DMA operations, the trap handler 134 reads the first tensor load/store operation and descriptor from the context save and restore region 302 of the global memory 106 and determines the count of how many descriptors were saved during the context switch based on the count indicated by the metadata. If the metadata indicates that the number of outstanding tensor load/store operations for the wave is non-zero, the trap handler sends a tensor load instruction 422 to the DMA controller 128. In some implementations, the trap handler 134 must hard-code an instruction (e.g., either load or store), and in the illustrated implementation, the hard-coded instruction is a tensor load instruction 422.

The DMA controller 128 receives the tensor load instruction 422 for ACTIVE TENSOR A+descriptor 212 and its associated metadata 312. The metadata 312 indicates that ACTIVE TENSOR A is a context resume tensor and includes the original ISA fields for ACTIVE TENSOR A. In addition, in some implementations the metadata 312 indicates whether the original instruction is a load or store operation. As noted above, the trap handler 134 issues a tensor load instruction 422 for the context resume tensor, regardless of whether the original instruction is a load or store operation. Accordingly, based on the indication in the metadata 312 that ACTIVE TENSOR A is a context resume tensor, the DMA controller 128 interprets the tensor load/store operation as a load operation or a store operation based on the metadata 312 rather than on the operation type of the tensor load instruction 422. The DMA controller 128 then stores ACTIVE TENSOR A and descriptor 212 in one of the context restore slots 220. Based on the count of how many descriptors were saved during the context switch indicated in the metadata 312 (which is two in the illustrated example), the trap handler 134 reads the next tensor load/store operation and descriptor (ACTIVE TENSOR B and descriptor 214) with its associated metadata (metadata 314) from the context save and restore region 302 of the global memory 106 and sends another tensor load instruction 422 to the DMA controller 128. The DMA controller 128 stores ACTIVE TENSOR B and descriptor 214 to the next context restore slot 220. Once the trap handler 134 has completed sending all the descriptors saved at the context save and restore region 302 for the wave, the trap handler 134 exits. The DMA controller 128 reads the descriptor 212 and the descriptor 214 and unrolls memory operations 230 required for each of the descriptor 212 and the descriptor 214.

In some implementations, additional tensor load/store operation instructions may be received by the DMA controller 128 while a context restore is in progress. Such additional tensor load/store operation instructions are stored with their descriptors in the user space slots 210. The DMA controller 128 prioritizes unrolling descriptors for tensor load/store operations stored in the context restore slots 220 over those stored in the user space slots 210 in some implementations. In other implementations, prioritization between tensor load/store operations and descriptors stored at the user space slots 210 versus the context restore slots 220 is configurable. For example, in some embodiments the DMA controller 128 alternates between unrolling descriptors saved at the user space slots 210 and descriptors saved at the context restore slots 220. In some embodiments, the DMA controller 128 unrolls one descriptor at a time, and in other embodiments, the DMA controller 128 partially or fully overlaps unrolling of two or more descriptors.

The DMA controller 128 is configured in some implementations with more context restore slots 220 than user space slots 210. For example, in some implementations each compute unit 120 includes four SIMD units 122, and each pair of SIMD units 122 is associated with a DMA controller 128. The scheduler 124 schedules work onto a compute unit 120, and the work is distributed to any of the SIMD units 122 of the compute unit 120. In some implementations, the number of tensor load/store operations that each DMA controller 128 can operate on at a given time is limited to avoid overflowing the user space slots 210. In some implementations, a sequencer (not shown) enforces the limit on the number of concurrent tensor load/store operations for each DMA controller 128. Upon context restore, the waves that had previously been assigned to a given SIMD unit 122 within a compute unit 120 may be assigned to another SIMD unit 122 within the same compute unit 120. As such, during context restore, tensor load/store operations that were previously divided between multiple (e.g., two) DMA controllers 128 may be restored to a single DMA controller 128. To accommodate the additional restored descriptors, the DMA controller 128 may have, for example, twice as many context restore slots 220 as user space slots 210 so the context restore slots 220 can hold the maximum number of tensor load/store operations that may be issued to a single DMA controller 128 during context resume operations.

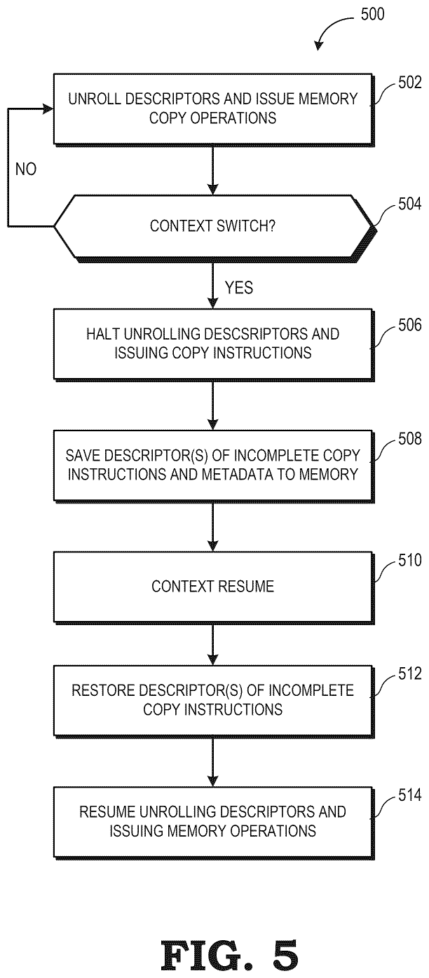

FIG. 5 is a flow diagram illustrating a method 500 for saving incomplete DMA copy operations for subsequent restoration in response to a context switch in accordance with some embodiments. In some implementations, the method 500 is performed at a processing system such as processing system 100.

The method begins at block 502, at which the shader 136 issues an instruction, such as tensor load/store operation instruction 204, to the DMA controller 128. The DMA controller 128 stores the tensor load/store operation and a descriptor in one of the user space slots 210 and hardware within the DMA controller 128 reads the descriptor and issues memory operations 230 required for the descriptor.

At block 504, the trap handler 134 determines if there is a context switch. If there is not a context switch, the method flow returns to block 502. If there is a context switch, the method flow continues to block 506.

In response to the context switch, the trap handler 134 sends a tensor stop instruction 320 to the DMA controller 128, instructing the DMA controller 128 to halt unrolling any descriptors that have not completed unrolling and stop issuing copy instructions.

At block 508, the trap handler 134 sends a tensor save instruction 322 to the DMA controller 128, instructing the DMA controller 128 to save a descriptor and metadata to the context save and restore region 302 of the global memory 106 for the wave for each outstanding tensor load/store operation (i.e., for each tensor load/store operation for which the DMA controller 128 has not completed issuing copy instructions).

At block 510, the wave that was preempted by the context switch resumes processing at the shader 136. At block 512, in response to the context resume, the trap handler 134 determines if the wave that is to be restored includes DMA operations and, if so, the trap handler 134 reads the first tensor load/store operation and descriptor from the context save and restore region 302 of the global memory 106 and reads the associated metadata to determine the number of descriptors that were saved during the context switch. If the number of saved descriptors is greater than zero, the trap handler 134 sends a tensor load instruction 422 to the DMA controller 128. In some implementations, even if the number of saved descriptors is zero, the trap handler 134 sends an operation to the DMA controller 128 to ensure the DMA controller 128 signals completion of the context restore to the scheduler 124. The scheduler 124 is thereby able to ensure that only a single context that may issue instructions to the DMA controller 128 is resumed at a time.

The DMA controller 128 then stores the restored descriptor(s) and associated metadata in one of the context restore slots 220. Once the trap handler 134 has completed sending all the descriptors saved at the context save and restore region 302 for the wave, the trap handler 134 exits. At block 514, the DMA controller 128 indicates to the scheduler 124 that the context resume is complete and resumes unrolling the restored descriptor(s) and issues memory operations 230 required for each of the restored descriptors. Upon receipt of the indication that the context resume is complete, the scheduler 124 can enable a new context resume. In some implementations, the restored descriptor(s) can be saved again, e.g., in response to another context switch, without requiring the restored descriptor(s) to complete unrolling.

In some embodiments, the apparatus and techniques described above are implemented in a system including one or more integrated circuit (IC) devices (also referred to as integrated circuit packages or microchips), such as the processing system described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
at a direct memory access (DMA) controller, issuing memory operations based on descriptors to copy data to and from a global memory of a parallel processor and a local memory of a shader executing at the parallel processor; and
in response to a context switch at the shader, halting issuing memory operations at the DMA controller.

2. The method of claim 1, further comprising:
saving at least one descriptor of incomplete memory operations to a region of the global memory.

3. The method of claim 2, further comprising:
saving metadata associated with the at least one descriptor to the region of the global memory, wherein the metadata indicates that the at least one descriptor is a restored descriptor.

4. The method of claim 3, wherein the metadata further indicates a number of descriptors of incomplete memory operations saved to the region of the global memory.

5. The method of claim 2, further comprising:
receiving the at least one descriptor of incomplete memory operations at the DMA controller in response to a context resume at the shader.

6. The method of claim 5, further comprising:
resuming issuing memory operations based on the at least one descriptor of incomplete memory operations to copy data to and from the global memory of the parallel processor and the local memory of the shader.

7. The method of claim 6, further comprising:
prioritizing issuing memory operations based on the at least one descriptor of incomplete copy operations over issuing instructions based on a descriptor received at the DMA controller subsequent to the context resume at the shader.

8. A parallel processor, comprising:
a shader to execute program instructions;
a local memory associated with the shader; and
a direct memory access (DMA) controller to:
issue instructions based on descriptors to perform copy operations to copy data to and from a global memory and the local memory; and
halt performing copy operations in response to a context switch at the shader.

9. The parallel processor of claim 8, wherein a trap handler associated with the shader is to:
save at least one descriptor of incomplete copy operations to a region of the global memory.

10. The parallel processor of claim 9, wherein the trap handler associated with the shader is to:
save metadata associated with the at least one descriptor to the region of the global memory, wherein the metadata indicates that the at least one descriptor is a restored descriptor.

11. The parallel processor of claim 10, wherein the metadata further indicates a number of descriptors of incomplete copy operations saved to the region of the global memory.

12. The parallel processor of claim 9, wherein the DMA controller is to:
receive the at least one descriptor of incomplete copy operations in response to a first context resume at the shader.

13. The parallel processor of claim 12, wherein the DMA controller is to:
resume issuing instructions based on the at least one descriptor of incomplete copy operations to copy data to and from the global memory of the parallel processor and the local memory of the shader.

14. The parallel processor of claim 13, wherein the DMA controller is to:
prioritize issuing instructions based on the at least one descriptor of incomplete copy operations over issuing instructions based on a descriptor received at the DMA controller subsequent to the first context resume at the shader.

15. The parallel processor of claim 13, further comprising:
a scheduler to initiate a second context resume in response to receiving an indication from the DMA controller that the first context resume has completed.

16. A system, comprising:
a global memory;
a parallel processor comprising:
a shader to execute program instructions;
a local memory associated with the shader; and
a trap handler; and
a direct memory access (DMA) controller to:
issue instructions based on descriptors to perform copy operations to copy data to and from a global memory and the local memory, wherein the trap handler is to instruct the DMA controller to stop issuing instructions in response to a context switch at the shader.

17. The system of claim 16, wherein the trap handler is to:
instruct the DMA controller to save at least one descriptor of incomplete copy operations and associated metadata to a region of the global memory.

18. The system of claim 17, wherein the associated metadata indicates that the at least one descriptor is a restored descriptor and a number of descriptors of incomplete copy operations saved to the region of the global memory.

19. The system of claim 17, wherein the trap handler is to read the at least one descriptor of incomplete copy operations and associated metadata from the region of the global memory in response to a context resume.

20. The system of claim 19, wherein the trap handler is to:
instruct the DMA controller to receive the at least one descriptor of incomplete copy operations in response to the context resume at the shader.

21. The system of claim 20, wherein the DMA controller is to:
resume issuing instructions based on the at least one descriptor of incomplete copy operations to copy data to and from the global memory of the parallel processor and the local memory of the shader.
